(19) United States
(12) Patent Application Publication
(10) Pub. No.: US 2021/0255098 A1
(43) Pub. Date: Aug. 19, 2021

(54) SYSTEM AND METHOD FOR IMPROVING PRECISION IN OPTICAL MEASUREMENTS

(71) Applicant: Insight Analytical Solutions Inc., Calgary (CA)

(72) Inventors: Kurt Trefiak, Edgerton, Alberta (CA); Philip C. Harris, Calgary, Alberta (CA)

(21) Appl. No.: 17/049,263

(22) PCT Filed: Apr. 23, 2019
(86) PCT No.: PCT/CA2019/050509

§ 371 Date: Oct. 20, 2020

Related U.S. Application Data
(60) Provisional application No. 62/661,427, filed on Apr. 23, 2018.

(51) Int. Cl. G01N 21/359; G01N 21/85; G01N 21/39

(52) U.S. Cl. CPC G01N 21/359; G01N 2201/06113; G01N 21/39; G01N 21/85

(57) ABSTRACT

A system and method for measuring properties of an analyte involving an optical analyzer connected to a flow cell assembly defining an optical path, and including a light source for directing light to the analyte and configured to measure light emitted from the analyte, during its flow through the optical path of the flow cell. The system and method involves interruption of analyte flow through the optical path for defined internals to improve precision in measurements by the optical analyzer.

### FIELD OF THE INVENTION

The present invention pertains to the field of measuring properties of an analyte via optical analyzers. In particular the invention relates to a system and method involving flow interruption of an analyte through a flow cell to improve precision in measurements by optical analyzers, measuring properties of process fluid streams.

### BACKGROUND OF THE INVENTION

Within the oil and gas industry, there is a constant need to analyze and evaluate the composition and properties of sample from process fluid stream. Optical analyzers are typically used in process applications due to their rapid analysis speed, no requirement for filtration due to lack of precision machined moving parts, and solid-state electronics platforms that offer significant improvements in reliability compared to conventional on-line continuous process analyzer technologies. Current flow cell designs are able to operate at line pressure and temperature and do not require elaborate sample conditioning systems.

However, the nature of the measurement requires that the light not be randomly obscured by “bodies” in the optical path. In the case of vapor entrainment, there are many cases where the sample is operating near the bubble point such as the outlet of a fractionation tower, stabilizer, separator, or bubble eliminator where the liquid is in equilibrium with the vapor phase. As a bubble passes through the flow cell, it diffracts the light and creates two issues. First, it reduces the overall amount of light that is transmitted. Second, the bubble acts like a prism that defracts the light of the range of wavelengths in such a way that reduces the transmission of small wavelength bands, thus inducing noise on the overall spectral scan. The modelling software must be sensitive to the absorption bands in order to measure the slight differences within the sample being measured. The random noise generated by bubbles results in a failure to produce stable and accurate readings.

Attempts have been made to resolve such issues. In traditional analyzers like gas chromatographs, various techniques are used to condition the sample such that the analyzer can provide reliable service. However, sample conditioning systems are complex and time-consuming to maintain that it is generally considered in the analytical process industry that 80% of maintenance is performed on the sample system. The techniques used for traditional analyzers work for optical measurements, are expensive, complex and generally require the pressurized system to be opened up by service technicians for maintenance which can be hazardous in terms of exposure and potential for fire and explosions. These techniques include using equipment such as depth filters, liquid/liquid filters, gravity separators, inertial filters, vapor eliminators, pressure regulators, needle valves, pumps, and coolers.

Some efforts have been made to suppress or control bubbles during optical property measurements of liquid samples. U.S. Pat. No. 4,740,709 discloses a specifically designed device for reducing interference of the bubbles, wherein the flow velocity of the sample is reduced by passing the sample via a small orifices and making it flow through a large diameter cell. U.S. Pat. No. 6,640,321 discloses a system and method, and teaches controlling bubbles in optical measurement cell by vibrating, stirring, rotating or agitating the sample cell. U.S. Pat. No. 9,335,250 discloses a bubble suppressing system, which uses pressure to reduce the size of the bubbles or collapse them completely. These systems would not be suitable for samples from process fluid streams flows that transport bubbles and particulates.

One of the potential drawbacks to an optically based measurement is fouling of the optics that are in contact with the process fluid sample. Contaminants (for example, wax, asphaltenes, iron sulphides and others) can coat the optics surfaces over time, reducing the overall amount of light transmission.

Some methods for cleaning in-process optic surfaces require removing the optics from service, either by physical removal of the sensor from the process installation or by isolating (valving off) the optics from the process. Both of these methods can be time consuming, especially if the optics surface fouls quickly. These methods are potentially dangerous, for example, for the processes involving toxic or otherwise hazardous chemicals. These methods may also harm the equipment. Moreover, the process itself, in addition to the process measurement, may be suspended until after cleaning has been completed.

In some systems a cleaning fluid is directed at the optics during operation. These systems are limited to those where the process is not detrimentally affected by addition of the cleaning fluid.

Mechanical methods have also been developed for cleaning of in-process optics. Such methods involve use of wipers, brushes, and the like to physically scrape contaminants off the sensor. Disadvantages of these methods include limited use with viscous process streams, the necessity to suspend the process measurement, and difficulty in designing a mechanical cleaning device into the process equipment, especially for a process containing corrosive or otherwise hazardous streams.

Ultrasound has been applied to cleaning of in-process optics. The use of ultrasound generates cavitation near the sensor to remove solids. However, ultrasound is limited to use with low solids and viscosity process streams, at pressures below 100 psig, certain temperatures, and streams with low specific gravity.

Accordingly, there is a need for improved systems and methods which achieve precision in measurements and mitigate these limitations of current optical analyzer systems.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a system and method for improving precision in optical measurements.

In accordance with an aspect of the present invention, there is provided a system for measuring one or more properties of an analyte, comprising a flow cell assembly comprising an optical path through which the analyte flows, an optical analyzer comprising a light source for directing light through the analyte, and a detector configured to analyze light transmitted through the analyte, wherein the light source and the detector operably connected to the flow cell assembly. The system further comprises a flow interruption valve in fluid communication with the flow cell assembly, wherein the valve is movable between an open position and a closed position for one or more defined intervals to interrupt analyte flow through the optical path to reduce light disrupting bodies entrained in the analyte in the optical path during measurement.

In accordance with another aspect of the invention, there is provided a method for measuring one or more properties of an analyte, which comprise: allowing the analyte to flow through an optical path of a flow cell assembly connected to an optical analyzer, the optical analyzer comprising a light source for directing light through the analyte and a detector configured to analyze light transmitted through the analyte; and interrupting analyte flow through the optical path for one or more defined intervals, and allowing light disrupting bodies entrained in the analyte to separate from the analyte in the optical path during measurement.

Additional aspects and advantages of the present invention will be apparent in view of the description, which follows.

### BRIEF DESCRIPTION OF THE DRAWINGS

The invention will now be described by way of an exemplary embodiment with reference to the accompanying simplified, diagrammatic, not-to-scale drawings. In the drawings:

FIG. 1 is a schematic depiction of a typical liquid optical process analyzer (i.e., a Near-Infrared Tunable Laser) and a sample flow cell assembly.

FIG. 2 is a schematic depiction of a system in accordance with an embodiment of the present invention.

FIG. 3 is a schematic depiction of a system in accordance with another embodiment of the present invention.

FIG. 4 shows an example of a flow interruption valve suitable for use in the system in accordance with the present invention.

FIG. 5 is a comparison of spectra obtained for measuring vapor pressure of crude oil in kP, using a typical flow cell assembly system and an exemplary system in accordance with the present invention.

FIG. 6 is an example of a noisy spectrum obtained by a typical flow cell assembly system showing fine structure deviation caused by light disrupting bodies in the optical path of a flow cell assembly.

FIG. 7 is an example of a clean spectrum obtained via an exemplary system in accordance with the present invention.

### DETAILED DESCRIPTION

Unless defined otherwise, all technical and scientific terms used herein have the same meaning as commonly understood by one of ordinary skill in the art to which this invention belongs.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

As used herein, the term “analyte” or “sample” refers to a fluid (gas or liquid) whose physical properties and/or chemical constituents are being identified and measured. In one embodiment, the analyte comprises a hydrocarbon-containing gas or liquid. As used herein, the term “hydrocarbon” broadly refers to any compound containing primarily carbon and hydrogen, and optionally one or more hetero atoms such as O, S, N, etc., and particularly occurring in petroleum, natural gas, natural gas liquids, coal, bitumen, condensate, crude oil, refined products, and the like.

As used herein, the term “property” refers to any chemical or physical parameter of the analyte. In one embodiment, the property includes, but is not limited to, hydrocarbon composition, vapor pressure, API gravity, BTU, relative density, specific gravity, vapor pressure, carbon dioxide gas, and other custody transfer measurements and requirements, excluding flow rate.

As used herein, the term “optical analyzer” broadly refers to any instrumentation which includes light source to direct light through an analyte, and a detector to measure absorption, transmission, phase shift, or emittance of light in order to determine chemical and physical properties of the analyte.

As used herein, the term “light disrupting bodies” refer to bubbles, water, other non-miscible fluids, and particulate/solids, that interfere with the manner light is transmitted through the flow cell as they can absorb, diffract and reflect the incident light in the optical path having a similar effect to bubbles. Some fluid streams can be heavily laden with such contaminants.

It was surprisingly discovered that interrupting the flow of an analyte for short intervals through the optical path of an optical cell in an optical measurement system not only improves the accuracy and reliability of the extracted data related to the chemical and physical properties of the analyte, but also helps in removing light disruptive bodies from the optic surfaces.

When the flow of the analyte is ceased, due to the differences in density between analyte, and light disrupting bodies such as bubbles, water, and particulates, any bubbles immediately rise out of the optical path and no longer cause any interference on the spectrum. The water and particulates that typically have a heavier density than the analyte are given time to settle, leaving a clear optical path to allow for precision measurement of the chemical and physical properties of the analyte.

High flow rates may introduce optical noise by increasing the transport of bubbles and particles into the optical path and also by inducing turbulence which results in flow induced noise. By operating for short periods with high flow rates which induce optical noise from bubbles and swirl, the system is rendered self-cleaning due to the high surface velocity and turbulence of the analyte which removes or scours away particulates from the optic lens as the analyte passes through the optical path. Flow interruption during measurement thus allows a noise free measurement in a self-cleaning system.

The present invention provides a system to achieve improved precision in measurement of one or more properties of an analyte by optical analyzers. The system comprises a flow cell assembly comprising an optical path through which the analyte flows. The system also comprises an optical analyzer comprising a light source, operably connected to the flow cell assembly for directing light through the analyte, and a detector operably connected to the flow cell assembly and configured to analyze light transmitted from the analyte, and a flow interruption valve placed in fluid communication with the flow cell assembly. The valve is movable between an open position and a closed position for one or more defined intervals to interrupt analyte flow through the optical path.

Although the direction of flow of the analyte is generally bottom to top, the flow interruption valve can work equally as well with flow of the analyte from top to bottom, since the flow direction is inconsequential once the flow is interrupted.

In some embodiments, the flow interruption valve is positioned downstream of the flow cell assembly.

In some embodiments, when flow cell path is vertically upwards, the flow interruption valve is positioned above the flow cell assembly.

In some embodiments, the optical analyzer of the system is selected from a Near Infrared spectrometer (IR), Fourier Transform Infra Red spectrometer (FT-IR), Fourier Transform Near Infrared spectrometer (FT-NIR), Ultraviolet absorption spectrometer (UV), Visible spectrometer (VIS), Raman Spectrometer, Laser-Near Infrared (“NIR”) process analyzer.

In some embodiments, the optical analyzer of the system comprises a broadly tuned Laser-NIR process analyzer.

The flow interruption valve can be an angle valve, a ball valve, a diaphragm valve, a plug valve, a piston valve or any other valve suitable to interrupt the flow, in particular capable of sealing against high pressure and capable of remote activation. The method of activation may be pneumatic, electric, magnetic or via other mechanical means.

In one embodiment, a suitable flow interruption valve for use with the present invention comprises a commercially available angle-seat valve (Mark 2000 Angle-Seat Valve, Jordon Valve, Cincinnati, Ohio). In another embodiment, the flow interruption valve is a pneumatically actuated ball valve. In another embodiment, the flow interruption valve is an electrically actuated ball valve. In another embodiment, the flow interruption valve is an electrically actuated valve.

In accordance with another aspect, the present invention provides a method for measuring one or more properties of an analyte with improved precision. The method comprises allowing the analyte to flow through an optical path of a flow cell assembly connected to an optical analyzer comprising a light source for directing light to the analyte and a detector configured to analyze light transmitted through the analyte, and interrupting the analyte flow through the optical path for one or more defined intervals.

The present invention relies upon the differences in density between the analyte and the light disrupting bodies (such as bubbles, water, and particulates) to separate them from the analyte and reduce their quantity in the optical path to obtain a clean spectrum free of noise, thereby improving the accuracy and reliability of the extracted data relating to the chemical and physical properties of the analyte. As soon as the flow of the analyte ceases, any bubbles immediately rise to the top of the flow path and no longer cause any interference on the spectrum. The water and particulates that typically have a heavier density than the analyte (for example, hydrocarbons) are given time to settle, leaving a clear optical path to allow for precision measurement of the chemical and physical properties of the analyte.

The flow of the analyte is interrupted for short intervals to confer particular advantages. As used herein, the term “short” refers to brief time periods of seconds or minutes.

In some embodiments, the defined intervals are about 10 seconds to about 1 minute to cease analyte flow, and 10 seconds to about 1 minute to allow analyte flow.

In some embodiments, the defined intervals are about 1 minute to cease analyte flow, and about 1 minute to allow analyte flow.

In some embodiments, the defined intervals are about 30 seconds to cease analyte flow, and about 30 seconds to allow analyte flow

The on/off period does not have to be symmetrical since the programmable logic controller may be configured for example, for a 30 second flow period and a 60 second stop period.

The cycle period to start/stop flow of the analyte can be adjusted to meet the requirements of the application. Conventional optical analyzer make measurements that are considered to be continuous, with an update time typically between 1 and 30 seconds. Conventional mechanical analyzers, such as gas chromatographs, vapor pressure analyzers or other physical properties analyzers will often have cycle time of 5 to 20 minutes between measurements. While the flow interruption makes the measurement discontinuous, the potentially slower response time does not have negative impacts on the system performance. In the development of the present invention, initial testing showed that a “1 minute flowing, 30 seconds stopped” cycle worked well and has been found to be a good balance between speed of measurement and duty cycle on the valve. A valve rated for 1 million cycles should operate for over four years, continuously under this switching sequence before preventative maintenance would be required. Shorter cycle times (for example, about 15 seconds) are possible where the interference is from bubbles since they separate quickly.

Optical measurement may be interrupted during the flow period and turned on when the flow is stopped or can be left running continuously. In some embodiments, the measurement output from the analyzer is held in a “hold last known measurement” state until the next known good measurement from stopped flow can be analyzed. A time delay may be required once the flow is interrupted before the bubbles, water, and particulates have cleared the optical path.

The system and method of the present invention can be implemented in the oil and gas industry for upstream, midstream, or downstream liquid or gas phase hydrocarbon processing applications. In one embodiment, the invention is used in downstream hydrocarbon processing applications.

The incorporation of a flow interruption valve in the optical measurement system renders the analyzer resilient to changing process conditions or operating conditions that are much different than design conditions which can often be experienced in new facility construction. For example, with a continuous flow system, a design engineer may be faced with a requirement to supply the flow to the analyzer within a 1 to 2 lpm flow rate to ensure that the sample is recently extracted from the main process pipe (which determines the low flow limit) but the velocity is not so high as to release bubbles (determining the high flow limit). Due to variations in plant production rates, the preferred method of using a passive differential pressure source to drive the fast loop such as an orifice plate must be replaced by either a pump or control valve with a flow meter feedback signal which is costly for process service and requires significant maintenance. The flow interruption valve allows for significant variation in differential pressure from 0.5 psi to 50 psi and higher in some cases and the optical measurements will be equally valid under all process conditions.

To gain a better understanding of the invention described herein, the following examples are set forth. It will be understood that these examples are intended to describe illustrative embodiments of the invention and are not intended to limit the scope of the invention in any way.

### Examples

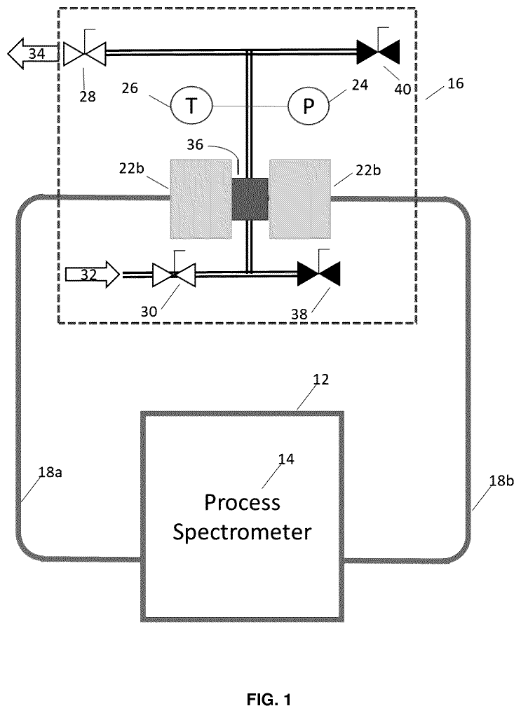

FIG. 1 is a schematic depiction of a typical optical property measurement system (10) comprising an enclosure (12) housing a process analyzer (14), such as NIR, tunable laser-NIR, FT-NIR, UV-Visor other spectrometer, which is operably connected to a flow cell assembly (16) via fiber optic cables (18a, 18b), and deployed into a process monitoring application in the hydrocarbon processing industry.

The operation of process analyzers (14) and flow cell assemblies (16) is commonly known to those skilled in the art and will not be discussed in detail.

The enclosure (12) also houses a microcomputer or programmable logic controller which can be used for various control functions in the process analyzer (14).

The flow cell assembly (16) generally comprises a pair of junction boxes (22a, 22b) for termination of the fiber optic cables (18a, 18b) extending from the process analyzer (14); a pressure transducer (24) for monitoring process pressure; a resistance temperature detector (26) for monitoring process temperature; upper and lower isolation valves (28, 30) for isolating the flow cell assembly (16) from the process for service/maintenance, without requiring shutdown; and a sample port (32) through which the fluid analyte (34) is collected and passes through an optical path flow cell (36). A low point drain valve (38) and laboratory grab sample point (40) is frequently provided.

Light is transmitted from the NIR spectrometer via the fiber optic cable (18a) through the fluid analyte (34) as it passes through the optical path flow cell (36). The light is returned to the NIR spectrometer which detects and measures the absorption, transmission, phase shift, or emittance of light by the fluid analyte (34) in order to yield a spectrum. The spectrum is processed and analyzed by the process analyzer (14) to determine data relating to the chemical and physical properties of the fluid analyte (34).

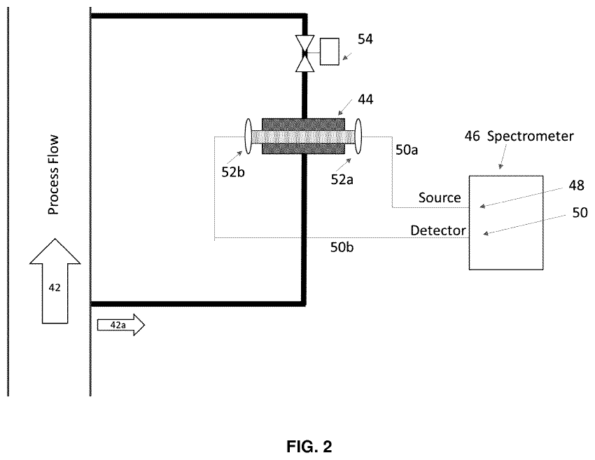

FIG. 2 is a schematic depiction of an embodiment of a system in accordance with the present invention, wherein a slipstream (42a) of process fluid (42) is allowed to flow through the sample flow cell assembly (44). A source (48) of a spectrometer (46) emits a beam of light which is transmitted by a fiber optic cable (50a) through the sample flow cell (44), where a collimating optic such as a lens (52) is used to collimate the beam of light as it passes through the process fluid. A second collimating optic (52b) is used to focus the beam of light back or a fiber optic (50b) where it is returned to the spectrometer detector (50). The spectrometer measures the transmitted light.

An automated interruption valve (54) is placed downstream and above of the flow cell assembly and controlled to close for a period of time, during which any bubbles in the sample rise out of the optical path and any matter denser than the process fluid falls out of the optical path. After this settling time is complete, the spectrometer records the spectrum of the “clean” process fluid. The interruption valve (54) is opened and sufficient volumetric flow rate of process fluid to clean the cell is allowed to pass through the sample flow path.

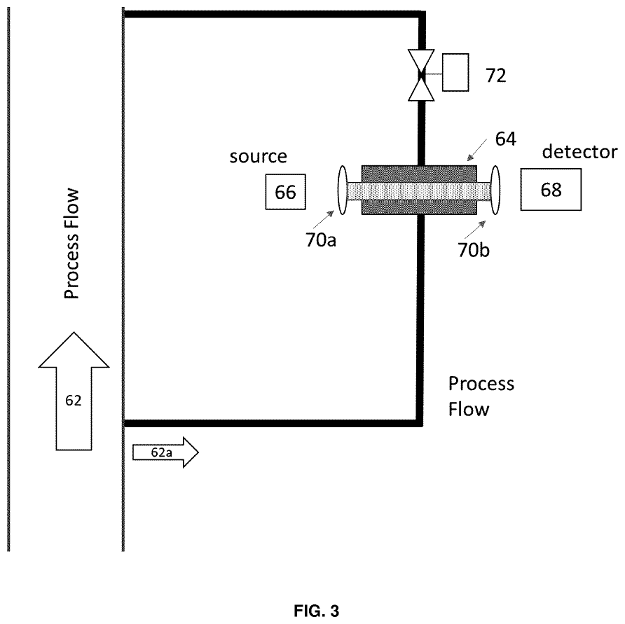

FIG. 3 is a schematic depiction of another embodiment of a system in accordance with the present invention. In this example, a slipstream (62a) of process fluid (62) is allowed to flow through the sample flow cell assembly (64), the light source (66) is mounted on one side of the flow cell and a detector 68 is mounted on the other side of the flow cell. A collimating optic (70a) is used to collimate the beam of light emitted from the source 66 and allow it to pass through the process fluid. A second collimating optic (70b) is used to collect the light and transfer it into the detector (68). An automated interruption valve (72) is placed downstream and above of the flow cell assembly and controlled to close for a predetermined period of time.

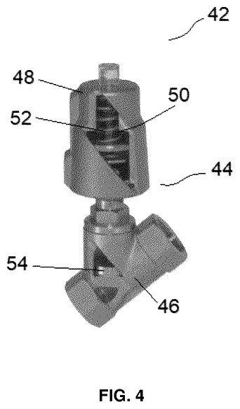

FIG. 4 shows an exemplary on/off flow interruption valve (82) for suitable for use in the system of the present invention. This embodiment of valve (82) comprises a substantially “Y”-shaped body (84) including an angle seat (86) to withstand high fluid flow rates. The fluid analyte enters the valve (82) under the seat (86) such that the valve (82) closes against the pressure of the flow. The valve (82) is thus normally closed, with flow of the fluid analyte under the seat (86). When air pressure is supplied to an actuator (88) (i.e., when the solenoid is energized open), a piston (90) is driven upwards to open the valve (82). When the solenoid is closed and the actuator (88) is vented, the springs (92) push a valve disc (94) to the seat (96) to close.

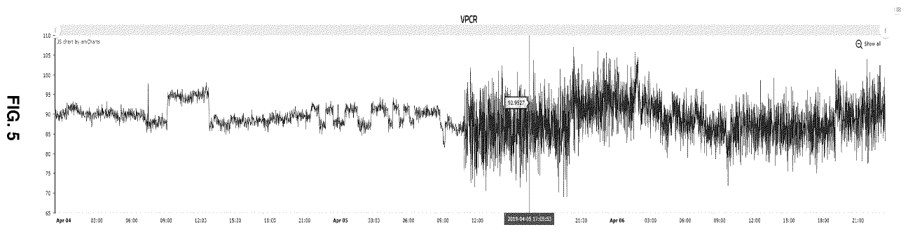

FIG. 5 is a comparison of spectra obtained for measuring vapor pressure in kP of crude oil. The left hand side spectrum was obtained when the flow interrupt valve is being used. The right hand side spectrum depicts performance when the flow interrupt valve is disable. In this instance, the use of the flow interrupt valve improved the signal to noise ratio by a factor of five.

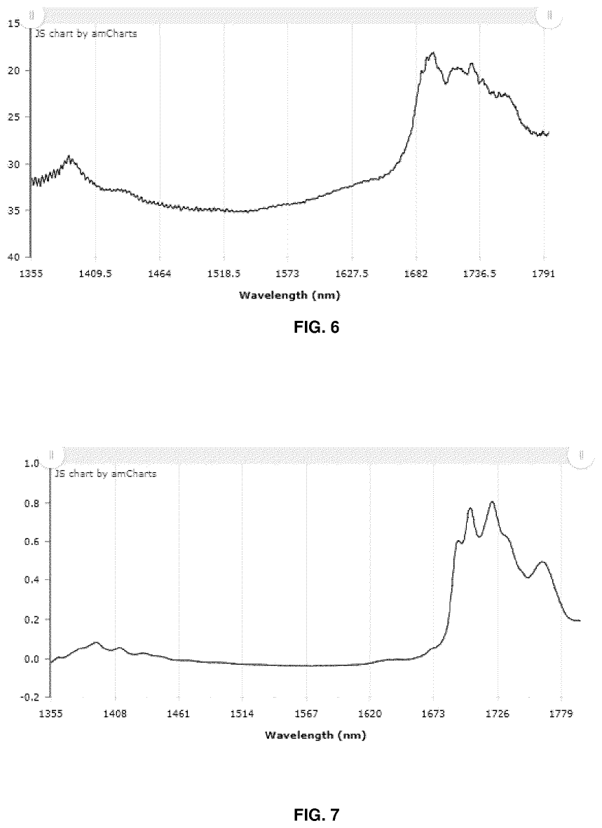

FIG. 6 is an example of a noisy spectrum obtained using a typical optical measurement system showing fine structure deviation caused by bubbles in the flow cell. The consequence of a noisy spectrum is that the extracted data for the fluid analyte may be inaccurate and unreliable.

FIG. 7 shows an example of a clean spectrum resulting from a system of the present invention involving interruption of analyte flow.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

1. A system for measuring one or more properties of an analyte, comprising:
a flow cell assembly comprising an optical path through which the analyte flows;
an optical analyzer comprising a light source for directing light through the analyte, and a detector configured to analyze light transmitted through the analyte, wherein the light source and the detector operably connected to the flow cell assembly; and
a flow interruption valve in fluid communication with the flow cell assembly, wherein the valve is movable between an open position and a closed position for one or more defined intervals to interrupt analyte flow through the optical path to reduce light disrupting bodies entrained in the analyte in the optical path during measurement.

2. The system of claim 1, wherein the flow interruption valve is positioned downstream of the flow cell assembly.

3. The system of claim 1, wherein the flow interruption valve is positioned above the flow cell assembly.

4. The system of claim 1, wherein the optical analyzer comprises Fourier Transform Infrared spectrometers (FT-IR), Fourier Transform Near Infrared spectrometers (FT-NIR), Ultraviolet absorption spectrometers (UV), Visible spectrometers (VIS), or Laser-Near Infrared (“NIR”) process analyzer.

5. The system of claim 4, wherein the optical analyzer comprises a broadly tuned Laser-Near Infrared (“NIR”) process analyzer.

6. The system of claim 1, wherein the flow interruption valve is an angle valve, a ball valve, a diaphragm valve, a plug valve, or a piston valve.

7. The system of claim 1, wherein the interval is about 10 seconds to about 1 minute in the closed position to cease analyte flow, and about 10 seconds to about 1 minute in the open position to allow analyte flow.

8. The system of claim 1, wherein the interval is about 30 seconds in the closed position to cease analyte flow, and about 30 seconds in the open position to allow analyte flow.

9. The system of claim 1, wherein the interval is about 60 seconds in the closed position to cease analyte flow, and about 30 seconds in the open position to allow analyte flow.

10. A method for measuring one or more properties of an analyte, comprising:
allowing the analyte to flow through an optical path of a flow cell assembly connected to an optical analyzer, the optical analyzer comprising a light source for directing light through the analyte and a detector configured to analyze light transmitted through the analyte; and
interrupting analyte flow through the optical path for one or more defined intervals, and allowing light disrupting bodies entrained in the analyte to separate from the analyte in the optical path during measurement.

11. The method of claim 10, wherein the defined interval is about 10 seconds to about 1 minute to cease analyte flow and 10 seconds to about 1 minute to allow analyte flow.

12. The method of claim 9, wherein the defined interval is about 30 seconds to cease analyte flow, and about 30 seconds to allow analyte flow.

13. The method of claim 9, wherein the defined interval is about 60 seconds to cease analyte flow, and about 30 seconds to allow analyte flow.

14. The method of claim 10, wherein the analyte flow is interrupted through the optical path flow cell using a flow interruption valve provided in communication with the flow cell assembly.

15. The method of claim 14, wherein the flow interruption valve is positioned downstream of the flow cell assembly.

16. The method of claim 14, wherein the flow interruption valve is positioned above the flow assembly cell.

17. The method of claim 14, wherein the optical analyzer comprises Fourier Transform Infrared spectrometers (FT-IR), Fourier Transform Near Infrared spectrometers (FT-NIR), Ultraviolet absorption spectrometers (UV), Visible spectrometers (VIS), or Laser-Near Infrared (“NIR”) process analyzer.
